(19) United States
(12) Patent Application Publication
(10) Pub. No.: US 2026/0226682 A1
(43) Pub. Date: Aug. 6, 2026

(54) HYBRID GAS/ELECTRIC AIR HEATING SYSTEM FOR MATERIAL DRYING SYSTEMS

(71) Applicants: CMPC TISSUE S.A., Santiago (CL); ANDRITZ CANADA INC., Montreal (CA)

(72) Inventors: Reinaldo Augusto URIBE ARANCIBIA, Pirque Santiago (CL); George Z. NOWAKOWSKI, Montreal (CA)

(21) Appl. No.: 19/149,920

(22) PCT Filed: Jan. 3, 2024
(86) PCT No.: PCT/IB2024/050056

§ 371 Date: Jul. 22, 2025

Related U.S. Application Data
(60) Provisional application No. 63/441,623, filed on Jan. 27, 2023.

(51) Int. Cl. D21F 5/18; F26B 13/18; F26B 21/35; F26B 21/37

(52) U.S. Cl. CPC D21F 5/18; F26B 13/186; F26B 21/35; F26B 21/37

(57) ABSTRACT

An air heating system includes a common air supply header, a common air return header, and a hybrid air heating system. The hybrid air heating system includes a first air heating system or a first set air heating components that operates using a first type of fuel and a second air heating system or a second set of air heating components that operates using a second type of fuel. The first type of fuel may be electricity and the second type of fuel may be a gas. The system may operate using only the first air heating system or components, only the second air heating system or components, or both the first and second air heating systems or components. Alternatively, a hybrid air heating system may be connected directly to an end of a dryer without the use of common headers.

### RELATED APPLICATION

This application claims priority to U.S. Ser. No. 63/441,623 entitled “Hybrid Natural Gas/Electric Air Heating System for Lignocellulosic Material Drying Systems,” filed Jan. 27, 2023, the entire contents of which is incorporated herein by reference.

### TECHNICAL FIELD

The present invention is generally related to the field of industrial pulp, paper, tissue, non-woven fabrics, fiber, and card stock drying, and more particularly is related to apparatuses, systems, and methods configured to dry lignocellulosic material while lowering greenhouse gas emissions.

### BACKGROUND

Drying systems are used extensively in the manufacture of paper, tissue, non-woven fabrics, and corrugated board. Examples of such drying systems include through air drying (“TAD”) systems, Yankee hood drying systems, and pulp dryer systems. Although drying systems differ, most drying systems utilize a process air recirculation system. These systems recapture process air that is used to dry the pulp, paper, tissue, card stock, non-woven web, etc. and reheat the air. The reheated air is re-introduced into the dryer to continue the drying process. Many process air recirculation systems use combustion burners to re-heat the process air. These combustion burners are powered by fossil fuels, commonly natural gas, or petroleum-derived fuels. The amount of greenhouse gases (e.g., carbon dioxide, methane, carbon monoxide etc.) emitted into the atmosphere is directly proportional to the amount of fossil fuels used to power the combustion burners.

An example of a Yankee hood drying system is shown in FIG. 1. The system includes a hood enclosure and a dryer cylinder 102. The hood enclosure has two halves, a wet end 110 and a dry end 120. The Yankee hood is connected to an external air heating system. The air heating system includes two separate and independent systems, one for the wet end and one for the dry end of the Yankee Hood. Each air heating system includes its own burner, combustion chamber, air circulating fan, and conduits, as well as other components. The same type of fuel is generally used in both air heating systems.

Air flow through the Yankee hood drying system of FIG. 1 is illustrated by FIG. 2. FIG. 2 illustrates that process air exits the wet end 210 and is reheated by air heater 212 and then re-introduced to the wet end. Supply fan 214 facilitates the circulation of the process air to and from the wet end. Separately, process air exits the dry end 220 and is reheated by air heater 222 and then re-introduced to the dry end. Supply fan 224 facilitates the circulation of the process air to and from the dry end.

### SUMMARY

An exemplary air drying system provides heated air to multiple ends of a dryer, e.g. the wet end and the dry end, using a common air supply header and a common air return header. The air drying system may include a hybrid air heating system. The hybrid air heating system may include two air heating systems that use different types of fuel (or sources of fuel) or may include a single air heating system that includes multiple sets of air heating components that use different types of fuel (or sources of fuel).

When the hybrid air heating system includes two air heating systems, the system may operate using only one of the air heating systems or both of the air heating systems. Each of the air heating systems is connected to the common air supply header and the common air return header. The process air outputs of the ends of the dryer are connected to the common air return header and the process air inputs of the ends of the dryer are connected to the common air supply header.

When operating using only one of the air heating systems, the air heating system receives process air from the common return header, heats the process air using a single type of fuel (or source of fuel), and provides the heated process air to the common supply header. The heated process air flows through the supply header to the process air inputs of the ends of the dryer. A circulating fan or similar device circulates the air through the air heating system, the common supply header, and the common return header.

When operating using both air heating systems, both systems receive process air from the common return header, each system heats the process air, and provides the heated process air to the common supply header. Each air heating system uses a different type of fuel to heat the process air. The heated air flows through the supply header to the process air inputs of the ends of the dryer. The circulating fan or other similar device in each system circulates the air through its associated air heating system, the common supply header, and the common return header.

The system may include dampers to control the flow of process air. A first pair of dampers may control air flow through a first air heating system and a second pair of dampers may control air flow through a second air heating system. In addition, there may be an optional pair of dampers that allows operation of only one end of a Yankee hood.

When the hybrid air heating system includes two sets of air heating components, the system may operate using only one set of air heating components or both sets of air heating components. The hybrid air heating system is connected to the common air supply header and the common air return header. The process air outputs of the ends of the dryer are connected to the common air return header and the process air inputs of the ends of the dryer are connected to the common air supply header.

When operating using only one set of air heating components, the air heating system receives process air from the common return header, heats the process air using one set of the air heating components that use a single type of fuel (or source of fuel), and provides the heated process air to the common supply header. The heated process air flows through the supply header to the process air inputs of the ends of the dryer. A circulating fan or similar device circulates the air through the air heating system, the common supply header, and the common return header.

When operating using both sets of air heating components, both sets of components heat the process air. Each set of air heating components uses a different type of fuel to heat the process air. The heated air flows through the supply header to the process air inputs of the ends of the dryer. The circulating fan or other similar device in each system circulates the air through its associated air heating system, the common supply header, and the common return header.

In an alternative exemplary air drying system, a hybrid air heating system provides heated air to one end of a dryer, e.g. the wet end or the dry end. The hybrid air heating system may include two sets of air heating components that use different types of fuel (or sources of fuel). The air drying system may use only one set of the air heating components or both sets of the air heating components to provide heated process air to one end of the dryer.

### BRIEF DESCRIPTION OF THE DRAWINGS

Aspects and features of the various embodiments will be more apparent by describing examples with reference to the accompanying drawings, in which:

FIG. 1 illustrates an exemplary Yankee hood drying system.

FIG. 2 illustrates exemplary air flow through the system of FIG. 1.

FIG. 3 illustrates an exemplary air drying system, in accordance with aspects of the invention.

FIG. 4 illustrates exemplary air flow through the system of FIG. 3.

FIG. 5 illustrates exemplary air flow through another exemplary air drying system, in accordance with aspects of the invention.

FIG. 6 illustrates another exemplary Yankee hood drying system.

FIG. 7 illustrates exemplary air flow through the system of FIG. 6.

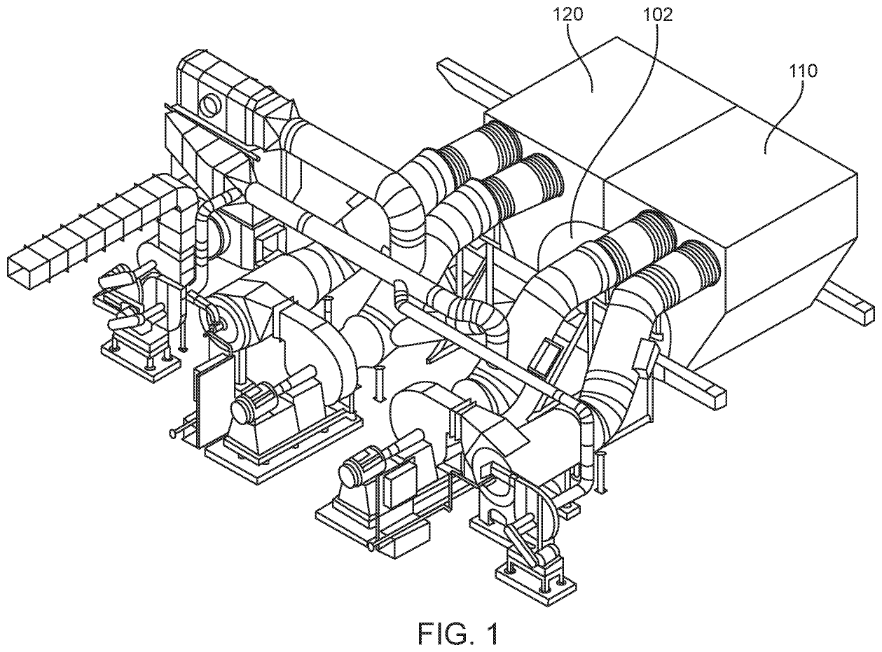

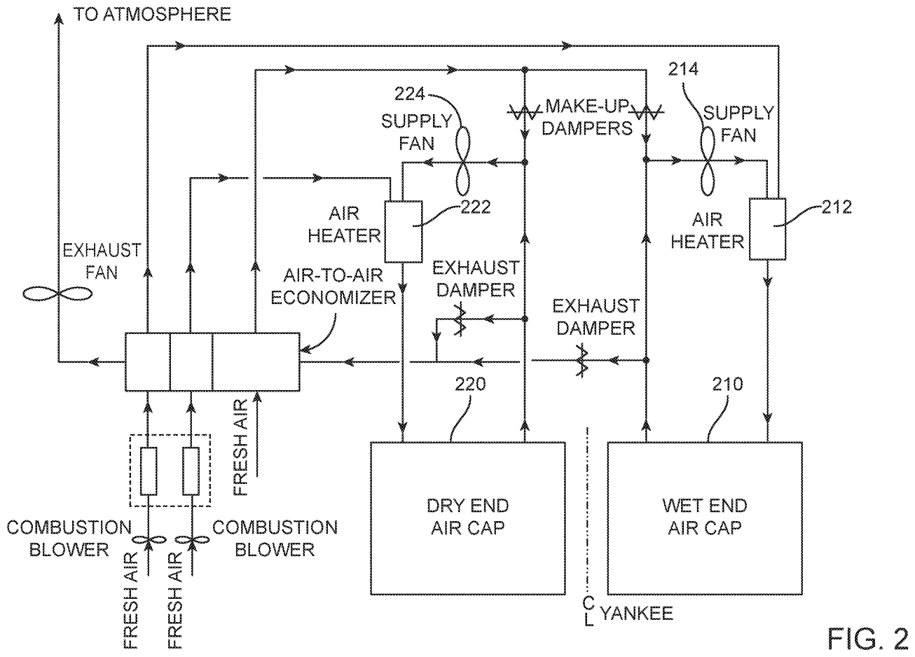

### DETAILED DESCRIPTION

While certain embodiments are described herein, these embodiments are presented by way of example only, and are not intended to limit the scope of protection. The apparatuses, methods, and systems described herein may be embodied in a variety of other forms.

Furthermore, various omissions, substitutions, and changes in the form of the example methods and systems described herein may be made without departing from the scope of protection.

Briefly described, in one example an air drying system provides heated air to the wet end and the dry end of a dryer using a common air supply header and a common air return header. The air drying system may include a hybrid gas/electric air heating system. The hybrid gas/electric air heating system may include two air heating systems, one gas air heating system and one electric air heating system or may include a single air heating system that includes gas air heating components and electric air heating components.

When two air heating systems are used, one or both of the air heating systems heat the process air. The air heating systems may use different types of fuel or sources of fuel. The systems may be controlled to select one of the air heating systems or to control the proportion of heated air provided by each air heating system based on emissions, fuel availability, or fuel cost considerations.

When a single air heating system is used, either or both of the gas air heating components and the electric air heating components heat the process air. The components may be controlled to use one set of components or to control the proportion of heated air provided by each set of components based on emissions, fuel availability, or fuel cost considerations.

The common air supply header and the common air return header allows for air flow crossover to both halves of the Yankee hood. When there are multiple air heating systems, either or both of the systems provide heated process air to both hood halves. When there is a single air heating system, either or both sets of air heating components provides heated process air to both hood halves. The common headers allow operation to continue even if one air heating system or one set of air heating components fails or is otherwise not operational. Without the common headers, if an air heating system for one of the hood halves is not operational, the hood half will not receive heated process air and condensation will form inside the hood half. The condensation may cause sheet breakage and interrupt production. With the common headers, the hood half receives heated process air from the other air heating system or the other set of air heating components and remains operational. Depending upon capacity, the operation with one air heating system or one set of air heating components may be at a reduced level of production.

Another consequence of a hood half not receiving heated process air is that dust may accumulate in the hood half. An accumulation of dust may be a safety issue since it creates a risk of sparks and even explosions.

### Air Drying System With Common Headers and Multiple Air Heating Systems

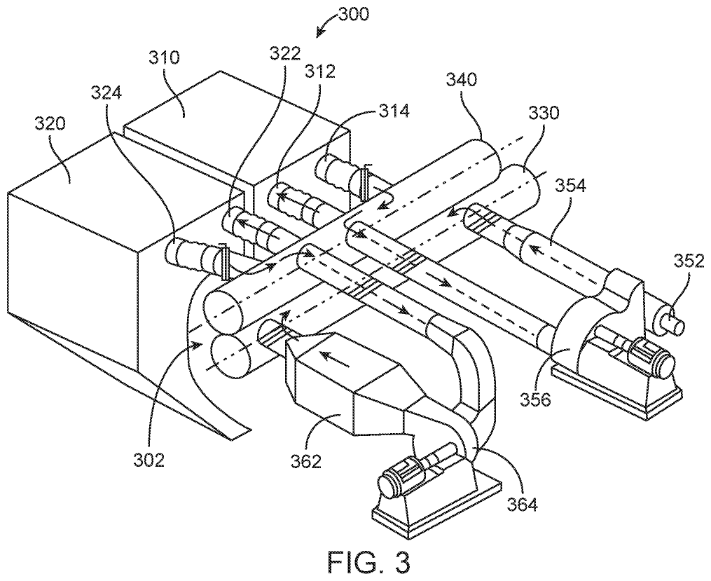

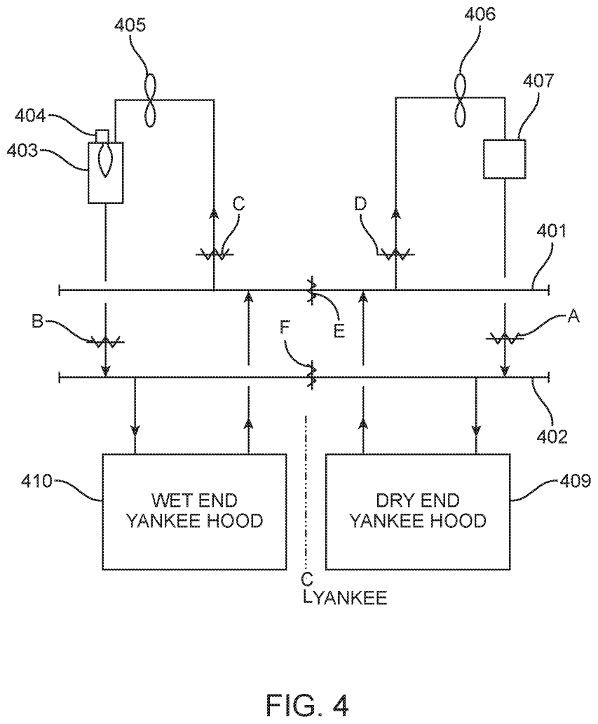

An exemplary air drying system may include a hybrid gas/electric air heating system that utilizes two air heating systems, one gas air heating system and one electric air heating system, as described below in connection with FIGS. 3 and 4.

An exemplary air heating system for a Yankee hood that includes a common air supply header and a common air return header is shown in FIG. 3. The system includes dryer 300 having a hood enclosure and a dryer cylinder 302. The hood enclosure has two halves, a wet end half 310, also referred to as a wet end, and a dry end half, also referred to as a dry end 320. The system includes a common air supply header or supply header 330 that is connected to the process air inputs of the wet end 312 and the dry end 322 and a common air return header or return header 340 that is connected to the process air outputs of the wet end 314 and the dry end 324. There are two air heating systems. A first air heating system uses a first type of fuel and a second air heating system uses a second type of fuel. For example, the first air heating system may be a natural gas air heating system and the second air heating system may be an electric air heating system. Alternatively, the first air heating system may be a hydrogen heating system or other type of gas heating system and the second air heating system may be an electric air heating system. Both air heating systems are connected to the common supply header and the common return header. In some implementations, the supply header, the return header, the natural gas air heating system, and the electric air heating system are located on a mezzanine floor adjacent to the dryer.

The connections between components may be provided by conduit. In one example, the dimensions of the conduit connecting the ends of the dryer to the supply header and the return header and the dimensions of the supply header and return header are selected so the diameters of the supply header and the return header are greater than twice the diameter of the conduit.

The system may operate using only the natural gas (or hydrogen) air heating system, only the electric air heating system, or both the natural gas (or hydrogen) air heating system and the electric air heating system. This flexibility provides certain non-limiting advantages, such as reducing greenhouse gas emissions by using the electric air heating system, reducing fuel costs by using the air heating system that uses lower cost fuel, or allowing operations to continue when one of the air heating systems is shut down.

The natural gas air heating system includes a burner 352, a combustion chamber 354, an air circulating fan 356, and conduit to connect to the supply header and the return header. For simplicity, FIG. 3 does not include all possible components of the natural gas air heating system. Additional components may include other equipment such as exhaust and make-up air components.

The electric air heating system includes an electric air heater 362, an air circulating fan 364, and conduit to connect to the supply header and the return header. For simplicity, FIG. 3 does not include all possible components of the electric air heating system. Additional components may include other equipment such as exhaust and air make-up components and an electric control system to regulate the air temperature of the electric air heating system.

Furthermore, the electric air heater may have a different form or design than that shown in FIG. 3.

When operating using only the natural gas air heating system, the natural gas air heating system receives process air from the return header 340, heats the process air using the burner 352 and the combustion chamber 354, and provides the heated process air to the supply header 330.

The heated process air flows through the supply header 330 to the process air inputs of the wet end 312 and the dry end 322. The used process air exits the process air outlets of the wet end 314 and the dry end 324 and flows into the return header 340. The air flows through the return header to the natural gas air heating system where it is reheated. The circulating fan 356 circulates the air through the natural gas air heating system, the supply header, and the return header.

When operating using only the electric air heating system, the electric air heating system receives process air from the return header 340, heats the process air using the electric air heater 362, and provides the heated process air to the supply header 330. The heated process air flows through the supply header to the process air inputs of the wet end 312 and the dry end 322. The used process air exits the process air outlets of the wet end 314 and the dry end 324 and flows into the return header. The air flows through the return header to the electric air heating system where it is reheated. The circulating fan 364 circulates the air through the electric air heating system, the supply header, and the return header.

When operating using both the natural gas air heating system and the electric air heating system both systems receive process air from the return header 340, heat the process air, and provide the heated process air to the supply header 330. The heated air from both systems is combined inside the supply header. The heated air flows through the supply header to the process air inputs of the wet end 312 and the dry end 322. The used process air exits the process air outlets of the wet end 314 and the dry end 324 and flows into the return header. The used process air from both the process air outputs of the wet end and the dry end is combined inside the return header. The air flows through the return header to the natural gas air heating system and to the electric air heating system where it is reheated. The circulating fan 356 in the natural gas air heating system circulates the air through the natural gas air heating system, the supply header, and the return header. The circulating fan 364 in the electric air heating system. circulates the air through the electric air heating system, the supply header, and the return header.

The capacity and capabilities of the components of the natural gas air heating system and the electric air heating system are selected to support operating the system using one or both air heating systems. For example, the following compares the outputs of the components when both systems are operating to the outputs when only the electric air heating system is operating in one exemplary implementation. The values given are exemplary and other systems may use different values. When operating using both the natural gas air heating system and the electric air heating system the components may operate as follows:
Natural gas air heating system: Air circulating fan 356 provides 50,000 CFM; burner 352 provides 5 MBTU/hr; and
Electric air heating system: Air circulating fan 364 provides 50,000 CFM; electric air heater 362 provides 5 MBTU/hr.

However, other configurations are possible including those where the volume and/or temperature of the air provided by the natural gas air heating system differs from that of the electric air heating system.

When operating using only the natural gas air heating system the components may operate as follows:
Natural gas air heating system: Air circulating fan 356 provides 100,000 CFM; burner 352 provides 10 MBTU/hr; and
Electric air heating system: Air circulating fan 364 provides 0 CFM; electric air heater 362 provides 0 MBTU/hr.

When operating using only the electric air heating system the components may operate as follows:
Natural gas air heating system: Air circulating fan 356 provides 0 CFM; burner 352 provides 0 MBTU/hr; and
Electric air heating system: Air circulating fan 364 provides 100,000 CFM; electric air heater 362 provides 10 MBTU/hr.

FIG. 3 illustrates one arrangement of the components of the air heating system. In other implementations, other arrangements of the components are used. For example, in other implementations, the return header may be located generally below the supply header, the electric air heater may be located adjacent to a conduit of the natural gas system or adjacent to the combustion chamber, the combustion chamber may be located adjacent to a conduit of the electric system or adjacent to the electric air heater, the circulating fan in the natural gas air heating system may be located on either side of the combustion chamber, and the circulating fan in the electric heating system may be located on either side of the electric air heater.

The system includes dampers to control the flow of process air. In one implementation, there are a first pair of dampers that control air flow through a first air heating system, e.g., the natural gas air heating system, and a second pair of dampers that control air flow through a second air heating system, e.g., the electric air heating system. The system may include optional dampers that allow operating only one end of the Yankee hood. FIG. 4 schematically illustrates the first pair of dampers B, C, the second pair of dampers A, D, and optional dampers E, F.

When operating using only the natural gas air heating system, dampers B and Care open, dampers A and D are closed, and dampers E and F are open. This configuration allows used process air to flow from the process air outputs of both halves of the Yankee hood into the return header 401 and then from the return header 401 into the natural gas air heating system 403, 404, 405. The natural gas air heating system heats the process air and the heated air flows into the supply header 402 and then it flows into the process air inputs of both halves of the Yankee hood. In this configuration, air flow through the electric air heating system 406, 407 is blocked because dampers A and D are closed.

When operating using only the electric air heating system, dampers A and D are open, dampers B and C are closed, and dampers E and F are open. This configuration allows used process air to flow from the process air outputs of both halves of the Yankee hood into the return header 401 and then from the return header 401 into the electric air heating system 406, 407. The electric heating system heats the process air and the heated air flows into the supply header 402 and then it flows into the process air inputs of both halves of the Yankee hood. In this configuration, air flow through the natural gas heating system 403, 404, 405 is blocked because dampers B and C are closed.

When operating using both the natural gas air heating system and the electric air heating system, dampers A, B, C, D, E and F are open. This configuration allows process air to flow into both the natural gas air heating system 403, 404, 405 and the electric air heating system 406, 407 from the return header 401, both air heating systems to heat the air, air to flow into the supply header 402 from both the natural gas air heating system and the electric air heating system, and air to flow into and out of the wet end 410 and the dry end 409 of the Yankee hood.

Dampers E and F allow operation of either the wet end or the dry end of the Yankee Hood. They may be closed when one of the air heating systems is shut down for maintenance, repair, or replacement to allow the other air heating system to operate with one end of the dryer. When operating only the wet end, dampers B and C are open and dampers A, D, E, and F are closed. This configuration allows used process air to flow from the air output of the wet end into the return header 401 and then into the natural gas air heating system 403, 404, 405. After the natural gas air heating system heats the process air, it flows into the supply header 402 and then into the air input of the wet end 410. This configuration blocks air flow through the electric air heating system 406, 407 and the dry end 409.

When operating only the dry end, dampers A and D are open and dampers B, C, E, and F are closed. This configuration allows process air to flow from the air output of the dry end into the return header 401 and then into the electric air heating system 406, 407. After the electric air heating system heats the process air, it flows into the supply header 402 and then into the air input of the dry end 409. This configuration blocks air flow through the natural gas air heating system 403, 404, 405 and the wet end 410.

Although FIG. 4 illustrates a configuration where the natural gas air heating system may be used to operate only the wet end and the electric air heating system may be used to operate only the dry end, other arrangements are possible, including an arrangement where the electric air heating system may be used to operate only the wet end and the natural gas air heating system may be used to operate only the dry end. For example, the electric air heating system may be connected to dampers B and C and the natural gas air heating system maybe connected to dampers A and D.

To allow operation of only the wet end or the dry end, dampers E and F and conduits connecting the wet end, dry end, and the air heating systems are arranged so that they can create an air flow path for one end (wet or dry) and one air heating system that is isolated from the other end and the other air heating system and their associated air flow paths. For example, dampers E and F may be located at approximately the midpoints of the return header and the supply header respectively. As shown in FIG. 3, the conduits for the natural gas heating system and the wet end may be connected to the same portion of the supply header and the same portion of the return header, where dampers E and F define the portions of the supply and return headers. The conduits for the electric air heating system and the dry end are connected to the same portion of the supply header and the same portion of the return header. Other configurations are also possible, including those where the conduits for the natural gas air heating system and the dry end are connected to the same portion of the supply header and the same portion of the return header and the conduits for the electric air heating system and the wet end are connected to the same portion of the supply header and the same portion of the return header.

A controller may be configured to monitor and control operations of the air heating system. The controller may control the opening and closing of the dampers to configure the system to operate using only the natural gas air heating system, only the electric air heating system, or both the natural gas air heating system and the electric air heating system. The controller may also control the operation of the burner, the electric air heater, and the fans to control the temperature of the air provided by each of the air heating systems and the relative volumes of air provided by each of the air heating systems. The temperature of the air and air flow volume of each air heating system may be the same or may differ. The temperature and air flow volumes may be selected based on the drying requirements of a particular drying system. The controller may be implemented using a PLC (programmable logic controller) or a DCS (distributed control system). The controller may include one or more computing devices, such as a processor, configured to execute computer-executable instructions stored on a computer-readable medium. Execution of the computer-executable instructions may configure the controller to perform the functions described herein.

The controller may operate with other hardware and software to optimize the air heating process. Sensors may measure the output of the electric air heating components and the gas air heating components, as well as other aspects of the system. The controller may receive information from the sensors and information regarding the fuel costs and availability for the each of the different fuels used by the air heating components. The controller may optimize the air heating process based on fuel cost and availability by adjusting the amount of heated air provided by the electric air heating components and the amount of heated air provided by the gas air heating components to meet the production and fuel requirements of the system. In one example, the controller is configured to seek the lowest specific energy consumption cost per ton of paper production or the lowest cost per KWs/Ton. This optimization may be automatically provided and maintained without requiring any actions from a human operator.

A system may be installed with only one air heating system and may be later modified to add a second air heating system. This allows a system to be built with minimal cost while allowing for later modification to meet future emissions or operating cost concerns. For example, an initial installation may include a supply header, a return header, and only a gas air heating system. Both the wet end and the dry end are connected to the supply header and the return header and the supply header and the return header are connected to the gas air heating system. There may be no openings in the supply header and the return header for a second air heating system or the openings may be sealed. In this configuration the system operates using only the gas air heating system. Subsequently, an electric air heating system is added and connected to the supply header and the return header. Once the electric air heating system is added, the system may operate using only the gas air heating system, only the electric air heating system or both heating systems.

### Air Drying System With Common Headers and Multiple Air Heating Components

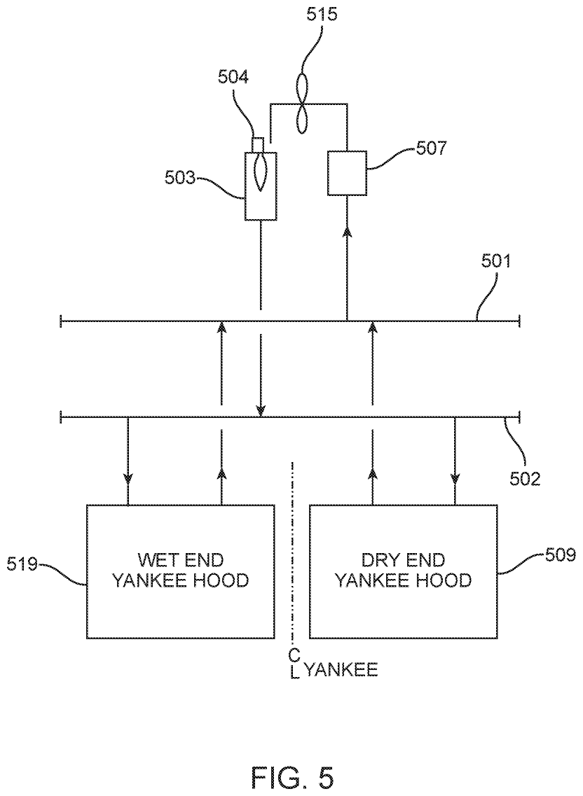

Another exemplary air drying system may include a hybrid gas/electric air heating system that has a single air heating system with both gas air heating components and electric air heating components as described below in connection with FIG. 5.

The system includes a dryer similar to that shown in FIG. 3 with a hood enclosure and a dryer cylinder. The hood enclosure has a wet end and a dry end. The system includes a common air supply header or supply header that is connected to the process air inputs of the wet end and the dry end and a common air return header or return header that is connected to the process air outputs of the wet end and the dry end. Instead of the two air heating systems shown in FIG. 3, there is a single air heating system. The single air heating system includes a first set of air heating components that uses a first type of fuel (or a first source of fuel) and a second set of air heating components that uses a second type of fuel (or a second source of fuel). For example, the first set of air heating components may be natural gas air heating components and the second set of air heating components may be electric air heating components. Alternatively, the first set of air heating components may hydrogen heating components and the second set of air heating components may be electric air heating components. The single air heating system is connected to the common supply header and the common return header. In some implementations, the supply header, the return header, and the air heating system are located on a mezzanine floor adjacent to the dryer.

The connections between components may be provided by conduit. In one example, the dimensions of the conduit connecting the ends of the dryer to the supply header and the return header and the dimensions of the supply header and return header are selected so the diameters of the supply header and the return header are greater than the diameter of the conduit.

The system may operate using only the natural gas (or hydrogen) air heating components, only the electric air heating components, or both the natural gas (or hydrogen) air heating components and the electric air heating components. This flexibility provides certain non-limiting advantages, such as reducing greenhouse gas emissions by using the electric air heating system, reducing fuel costs by using the air heating system that uses lower cost fuel, or allowing operations to continue when one set of the air heating components is unavailable.

FIG. 5 illustrates an air heating system that includes an air circulating fan 515, natural gas air heating components, and electric air heating components 507. The natural gas air heating components include a burner 504 and a combustion chamber 503. The electric air heating components include an electric air heater 507. For simplicity, FIG. 5 does not include all possible components of the air heating system. Additional components may include other equipment such as exhaust and make-up air components.

When operating using only the natural gas air heating components, the air heating system receives process air from the return header 501, heats the process air using only the natural gas air heating components 503, 504, and provides the heated process air to the supply header 502.

The heated process air flows through the supply header to the process air inputs of the wet end and the dry end. The used process air exits the process air outlets of the wet end and the dry end and flows into the return header. The air flows through the return header to the air heating system where it is reheated. The circulating fan 515 circulates the air through the air heating system, the supply header, and the return header.

When operating using only the electric air heating components, the air heating system receives process air from the return header 501, heats the process air using only the electric air heating components 507, and provides the heated process air to the supply header 330. The heated process air flows through the supply header to the process air inputs of the wet end and the dry end. The used process air exits the process air outlets of the wet end and the dry end and flows into the return header. The air flows through the return header to the air heating system where it is reheated. The circulating fan 515 circulates the air through the air heating system, the supply header, and the return header.

When operating using both the natural gas air heating components and the electric air heating components both sets of components are used to heat the process air received from the return header simultaneously. The air heating system receives process air from the return header 501, heats the process air using both the natural gas heating components and the electric heating components, and provides the heated process air to the supply header 330. The heated process air flows through the supply header to the process air inputs of the wet end and the dry end. The used process air exits the process air outlets of the wet end and the dry end and flows into the return header. The air flows through the return header to the air heating system where it is reheated. The circulating fan 515 circulates the air through the air heating system, the supply header, and the return header. The arrangement of the electric heater, fan, and combustion chamber shown in FIG. 5 is one example. In other systems, these components may be arranged differently relative to each other.

The capacity and capabilities of the components of the air heating system are selected to support operating the system using one or both sets of air heating systems components.

The system illustrated in FIG. 5 may be suitable for use in an exemplary system that produces paper widths in the range of 2.8 m and production outputs in the range of 100 T/day. In such a system, the following compares the exemplary outputs of the components when both sets of components are operating to the outputs when only the electric air heating components are operating in one possible implementation. The values given are exemplary and other systems may use different values. Since there is only a single fan, the operation of the fan does not depend upon how the air is heated, i.e., which set(s) of components heat the air.

When operating using both the natural gas air heating components and the electric air heating components in a system with a production output of 100 T/day, the components may operate as follows:
Natural gas air heating components: Burner 504 provides 5 MBTU/hr; and
Electric air heating components: Electric air heater 507 provides 5 MBTU/hr.

However, other configurations are possible including those where the amount of heating provided by the natural gas air heating components differs from that of the electric air heating components.

When operating using only the natural gas air heating components the components may operate as follows:
Natural gas air heating components: Burner 504 provides 10 MBTU/hr; and
Electric air heating components: Electric air heater 507 provides 0 MBTU/hr.

When operating using only the electric gas air heating components the components may operate as follows:
Natural gas air heating components: Burner 504 provides 0 MBTU/hr; and
Electric air heating components: Electric air heater 507 provides 10 MBTU/hr.

A controller may be configured to monitor and control operations of the air heating system. The controller may control the system to operate using only the natural gas air heating components, only the electric air heating components, or both the natural gas air heating system and the electric air heating components. The controller may also control the operation of the burner, the electric air heater, and the fan to control the temperature of the air provided by each of the air heating systems and the volume of air provided. The temperature of the air of each set of air heating components may be the same or may differ. The temperatures and air flow volumes may be selected based on the drying requirements of a particular drying system. The controller may be implemented using a PLC (programmable logic controller) or a DCS (distributed control system). The controller may include one or more computing devices, such as a processor, configured to execute computer-executable instructions stored on a computer-readable medium. Execution of the computer-executable instructions may configure the controller to perform the functions described herein.

The controller may operate with other hardware and software to optimize the air heating process. Sensors may measure the output of the electric air heating components and the gas air heating components, as well as other aspects of the system. The controller may receive information from the sensors and information regarding the fuel costs and availability for the each of the different fuels used by the air heating components. The controller may optimize the air heating process based on fuel cost and availability by adjusting the amount of heated air provided by the electric air heating components and the amount of heated air provided by the gas air heating components to meet the production and fuel requirements of the system. In one example, the controller is configured to seek the lowest specific energy consumption cost per ton of paper production or the lowest cost per KWs/Ton. This optimization may be automatically provided and maintained without requiring any actions from a human operator.

A system may be installed with only one set of air heating components and may be later modified to add a second set of air heating components. This allows a system to be built with minimal cost while allowing for later modification to meet future emissions or operating cost concerns. For example, an initial installation may include a supply header, a return header, and an air heating system that only includes gas air heating components. Both the wet end and the dry end are connected to the supply header and the return header and the supply header and the return header are connected to the air heating system. Subsequently, a set of electric air heating components is added to the air heating system. Once the electric air heating components are added, the system may operate using only the gas air heating components, only the electric air heating components or both sets of heating components.

### Air Drying System With Multiple Air Heating Components

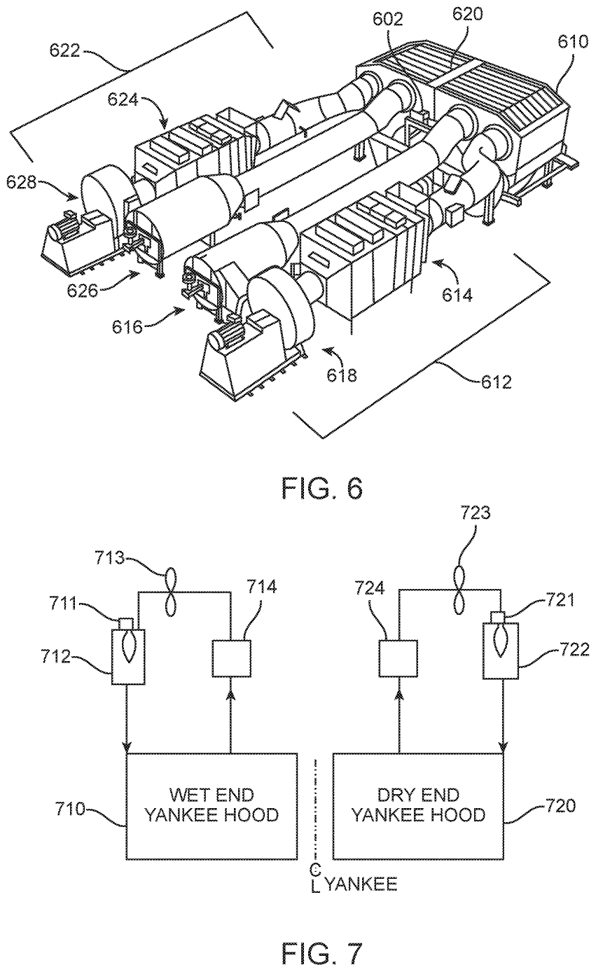

An alternative air drying system may include multiple hybrid natural gas/electric air heating systems. Each air heating system includes both gas air heating components and electric air heating components and is associated with one of the hood halves as described below in connection with FIGS. 6 and 7.

The system includes a dryer with a hood enclosure and a dryer cylinder 602. The hood enclosure has a wet end 610 and a dry end 620. The system includes one air heating system 612 connected to the wet end and another air heating system 622 connected to the dry end. Instead of the common headers shown in FIG. 3, each air heating system is connected to one hood half via conduit. Each air heating system is external to the hood and includes a first set of air heating components that uses a first type of fuel (or a first source of fuel), a second set of air heating components that uses a second type of fuel (or a second source of fuel), and a circulating fan 618, 628. For example, the first set of air heating components may be natural gas air heating components 616, 626 and the second set of air heating components may be electric air heating components 614, 624. Alternatively, the first set of air heating components may be hydrogen or another type of gas heating components and the second air heating system may be an electric air heating system. In some implementations, the air heating systems are located on a mezzanine floor adjacent to the dryer. For simplicity, FIG. 6 does not include all possible components of the air heating system. Additional components may include other equipment such as exhaust and make-up air components and an electric control system to regulate the air temperature of the electric air heating system. Furthermore, the electric air heater may have a different form or design than that shown in FIG. 6.

The system may operate using only the gas (natural gas, hydrogen gas, or other type of gas) air heating components, only the electric air heating components, or both the gas air heating components and the electric air heating components. This flexibility provides certain non-limiting advantages, such as reducing greenhouse gas emissions by using the electric air heating system, reducing fuel costs by using the air heating system that uses lower cost fuel, or allowing modified operations to continue when one set of the air heating components is unavailable.

FIG. 7 illustrates a first air heating system connected to the wet end 710 and a second air heating system connected to the dry end 709. The first air heating system includes an air circulating fan 713, natural gas air heating components 711, 712, and electric air heating components 714. The second air heating system includes an air circulating fan 723, natural gas air heating components 721, 722, and electric air heating components 724. The natural gas air heating components include a burner 711, 721 and a combustion chamber 712, 722. The electric air heating components include an electric air heater 714, 724. Each air circulating fans circulates process air through its respective air heating system by circulating the air through the combustion chamber and the electric air heater components and the conduit connecting the air heating components and the hood.

Each of the air heating systems operate by receiving process air from the process air output of one half, heating the process air as it flows through the air heating system using one or both sets of air heating components, and providing the heated process air to the process air input of the hood half.

The capacity and capabilities of the components of the air heating systems are selected to support operating the system using one or both sets of air heating systems components. The system illustrated in FIGS. 6 and 7 may be suitable for use in an exemplary system that produces paper widths in the range of 5.5 m and production outputs in the range of 200 T/day. In such a system, the following compares the exemplary outputs of the components when both sets of components are operating to the outputs when only the electric air heating components are operating. The values given are exemplary and other systems may use different values. Since there is only a single fan in each air heating system, the operation of the fan does not depend upon how the air is heated, i.e., which set(s) of components heat the air.

When operating using both the natural gas air heating components and the electric air heating components the components may operate as follows:
Air circulating fan provides 100,000 CFM
Natural gas air heating components: Burner provides 5 MBTU/hr; and
Electric air heating components: Electric air heater provides 5 MBTU/hr.

However, other configurations are possible including those where the amount of heating provided by the natural gas air heating components differs from that of the electric air heating components.

When operating using only the natural gas air heating components the components may operate as follows:
Air circulating fan provides 100,000 CFM
Natural gas air heating components: Burner provides 10 MBTU/hr; and
Electric air heating components: Electric air heater provides 0 MBTU/hr.

When operating using only the electric gas air heating components the components may operate as follows:
Air circulating fan provides 100,000 Cfm
Natural gas air heating components: Burner provides 0 MBTU/hr; and
Electric air heating components: Electric air heater provides 10 MBTU/hr.

A controller may be configured to monitor and control operations of the air heating system. The controller may control the system to operate using only the natural gas air heating components, only the electric air heating components, or both the natural gas air heating system and the electric air heating components, as well as controlling both air heating systems. The controller may also control the operation of the burner, the electric air heater, and the fan to control the temperature of the air provided by each of the air heating systems and the volume of air provided. The temperature of the air of each set of air heating components may be the same or may differ. The temperatures and air flow volumes may be selected based on the drying requirements of a particular drying system. The controller may be implemented using a PLC (programmable logic controller) or a DCS (distributed control system). The controller may include one or more computing devices, such as a processor, configured to execute computer-executable instructions stored on a computer-readable medium. Execution of the computer-executable instructions may configure the controller to perform the functions described herein.

The controller may operate with other hardware and software to optimize the air heating process. Sensors may measure the output of the electric air heating components and the gas air heating components, as well as other aspects of the system. The controller may receive information from the sensors and information regarding the fuel costs and availability for the each of the different fuels used by the air heating components. The controller may optimize the air heating process based on fuel cost and availability by adjusting the amount of heated air provided by the electric air heating components and the amount of heated air provided by the gas air heating components to meet the production and fuel requirements of the system. In one example, the controller is configured to seek the lowest specific energy consumption cost per ton of paper production or the lowest cost per KWs/Ton. This optimization may be automatically provided and maintained without requiring any actions from a human operator.

A system may be installed with only one set of air heating components and may be later modified to add a second set of air heating components. This allows a system to be built with minimal cost while allowing for later modification to meet future emissions or operating cost concerns. For example, an initial installation may include air heating systems that only include gas air heating components. Subsequently, a set of electric air heating components is added to each of the air heating systems. Once the electric air heating components are added, the system may operate using only the gas air heating components, only the electric air heating components or both sets of heating components.

A summary of exemplary illustrations is provided below, including some enumerated as an “Illustration,” in accordance with the concepts described herein.

Illustration 1. An air drying system, comprising: an air return header configured to receive process air from an output of a wet end of a Yankee hood and an output of a dry end of the Yankee hood and to provide process air to a gas air heating system or to an electric air heating system; an air supply header configured to receive process air from the gas air heating system or the electric air heating system and to supply process air to an input of the wet end of the Yankee hood and an input of the dry end of the Yankee hood; the gas air heating system, comprising: a first air circulating fan; a burner; and a combustion chamber; the electric air heating system, comprising: a second air circulating fan; and an electric air heater; and a plurality of dampers, wherein the dampers may be configured to provide process air to the air supply header by only the gas air heating system, only the electric air heating system, or both the gas air heating system and the electric air heating system.

Illustration 2. The air drying system of any preceding or subsequent illustration or combination of illustrations, wherein a first one of the plurality of dampers is located between an output of the electric air heating system and a first input of the air supply header and a second one of the plurality of dampers is located between an output of the gas air heating system and a second input of the air supply header.

Illustration 3. The air drying system of any preceding or subsequent illustration or combination of illustrations, wherein a third one of the plurality of dampers is located between a first output of the air return header and an input of the electric air heating system and a fourth one of the plurality of dampers is located between a second output of the air return header and an input of the gas air heating system.

Illustration 4. The air drying system of any preceding or subsequent illustration or combination of illustrations, wherein the plurality of dampers may be further configured to provide air from the air return header to only the gas air heating system, only the electric air heating system, or both the gas air heating system and the electric air heating system.

Illustration 5. The air drying system of any preceding or subsequent illustration or combination of illustrations, further comprising: a first conduit connecting the output of the wet end of the Yankee hood to the air return header; and a second conduit connecting the output of the dry end of the Yankee hood to the air return header, wherein a diameter of the first conduit is approximately equal to a diameter of the second conduit, and a diameter of the air return header is greater than twice the diameter of the first conduit.

Illustration 6. The air drying system of any preceding or subsequent illustration or combination of illustrations, further comprising: a third conduit connecting the input of the wet end of the Yankee hood to the air supply header; and a fourth conduit connecting the input of the dry end of the Yankee hood to the air supply header, wherein a diameter of the third conduit is approximately equal to a diameter of the fourth conduit, and a diameter of the air supply header is greater than twice the diameter of the third conduit.

Illustration 7. The air drying system of any preceding or subsequent illustration or combination of illustrations, further comprising a controller configured to control operation of the gas air heating system and the electric air heating system, wherein the controller is configured to control a temperature and a volume of air provided by the gas air heating system and a temperature and a volume of air provided by the electric air heating system.

Illustration 8. The air drying system of any preceding or subsequent illustration or combination of illustrations, further comprising a plurality of dampers for controlling process air out of the air return header and process air into the air supply header, wherein the controller is configured to control positions of the dampers.

Illustration 9. An air drying system, comprising: an air return header configured to receive process air from an output of a wet end of a Yankee hood and an output of a dry end of the Yankee hood and to provide process air to an air heating system; an air supply header configured to receive process air from the air heating system and to supply process air to an input of the wet end of the Yankee hood and an input of the dry end of the Yankee hood; the air heating system, comprising: an air circulating fan; gas air heating components including a burner and a combustion chamber; and electric air heating components including an electric air heater, wherein the air heating system is configurable to operate using only the gas air heating components, only electric air heating components, or both the gas air heating components and the electric air heating components.

Illustration 10. The air drying system of any preceding or subsequent illustration or combination of illustrations, further comprising a controller, wherein the controller controls the air heating system so that (i) the burner and the combustion chamber provide the process air from the air heating system when the air heating system is configured to operate using only the gas air heating components, (ii) the electric air heater provides the process air from the air heating system when the air heating system is configured to operate using only the electric air heating components, or (iii) the burner, the combustion chamber, and the electric air heater provide the process air from the air heating system when the air heating system is configured to operate using both the gas air heating components and the electric air heating components.

Illustration 11. The air drying system of any preceding or subsequent illustration or combination of illustrations, further comprising: a first conduit connecting the output of the wet end of the Yankee hood to the air return header; and a second conduit connecting the output of the dry end of the Yankee hood to the air return header, wherein a diameter of the first conduit is approximately equal to a diameter of the second conduit, and a diameter of the air return header is greater than twice the diameter of the first conduit.

Illustration 12. The air drying system of any preceding or subsequent illustration or combination of illustrations, further comprising: a third conduit connecting the input of the wet end of the Yankee hood to the air supply header; and a fourth conduit connecting the input of the dry end of the Yankee hood to the air supply header, wherein a diameter of the third conduit is approximately equal to a diameter of the fourth conduit, and a diameter of the air supply header is greater than twice the diameter of the third conduit.

Illustration 13. The air drying system of any preceding or subsequent illustration or combination of illustrations, further comprising: a fifth conduit connecting the air return header to an input of the air heating system; and a sixth conduit connecting an output of the air heating system to the air supply header.

Illustration 14. An air drying system, comprising: an air return header configured to receive process air from an output of a wet end of a Yankee hood and an output of a dry end of the Yankee hood and to provide process air to a hybrid gas/electric air heating system; an air supply header configured to receive process air from the hybrid gas/electric air heating system and to supply process air to an input of the wet end of the Yankee hood and an input of the dry end of the Yankee hood; the hybrid gas/electric air heating system, comprising: at least one air circulating fan; gas air heating components, comprising: a burner; and a combustion chamber; and an electric air heating components, comprising: an electric air heater; and a controller configured for controlling the hybrid gas/electric air heating system to operate using only the gas air heating components, only the electric air heating components, or both the gas air heating components and the electric air heating components.

Illustration 15. The air drying system of any preceding or subsequent illustration or combination of illustrations, wherein the controller is configured to control a volume of air provided by the at least one air circulating fan, a temperature provided by the gas air heating components, and a temperature provided by the electric air heating components.

Illustration 16. The air drying system of any preceding or subsequent illustration or combination of illustrations, further comprising: a first conduit connecting the output of the wet end of the Yankee hood to the air return header; and a second conduit connecting the output of the dry end of the Yankee hood to the air return header, a third conduit connecting the input of the wet end of the Yankee hood to the air supply header; and a fourth conduit connecting the input of the dry end of the Yankee hood to the air supply header, wherein a diameter of the third conduit is approximately equal to a diameter of the fourth conduit, and a diameter of the air supply header is greater than twice the diameter of the third conduit.

Illustration 17. The air drying system of any preceding or subsequent illustration or combination of illustrations, further comprising: a fifth conduit connecting the air return header to an input of the hybrid gas/electric air heating system; and a sixth conduit connecting an output of the hybrid gas/electric air heating system to the air supply header.

Illustration 18. The air drying system of any preceding or subsequent illustration or combination of illustrations, further comprising: a fifth conduit connecting the air return header to a first input of the hybrid gas/electric air heating system associated with the gas air heating components; a sixth conduit connecting the air return header to second input of the hybrid gas/electric air heating system associated with the electric air heating components; a seventh conduit connecting a first output of the hybrid gas/electric air heating system associated with the gas air heating components to the air supply header; and an eighth conduit connecting a second output of the hybrid gas/electric air heating system associated with the electric air heating components to the air supply header.

Illustration 19. The air drying system of any preceding or subsequent illustration or combination of illustrations, wherein a first air circulating fan of the hybrid gas/electric air heating system is associated with the gas air heating components and a second air circulating fan is associated with the electric air heating components.

Illustration 20. The air drying system of any preceding or subsequent illustration or combination of illustrations, further comprising a plurality of dampers for controlling process air out of the air return header and into the hybrid gas/electric air heating system and process air out of the hybrid gas/electric air heating system into the air supply header, wherein the controller is configured to control positions of the dampers.

Illustration 21. An air drying system, comprising: a first conduit configured to receive process air from an output of a first end of a Yankee hood and to provide process air to a first air heating system; a second conduit configured to receive process air from the first air heating system and to provide process air to an input of the first end of the Yankee hood; and the first air heating system, comprising: a first air circulating fan; a first set of gas air heating components including a burner and a combustion chamber; and a first set of electric air heating components including an electric air heater, wherein the first air heating system is external to the Yankee hood and is configurable to operate using only the first set of gas air heating components, only the first set of electric air heating components, or both the first set of gas air heating components and the first set of electric air heating components.

Illustration 22. The air drying system of any preceding or subsequent illustration or combination of illustrations, further comprising a controller, wherein the controller controls the first air heating system so that (i) the burner and the combustion chamber provide the process air from the first air heating system when the first air heating system is configured to operate using only the first set of gas air heating components, (ii) the electric air heater provides the process air from the first air heating system when the first air heating system is configured to operate using only the first set of electric air heating components, or (iii) the burner, the combustion chamber, and the electric air heater provide the process air from the first air heating system when the first air heating system is configured to operate using both the first set of gas air heating components and the first set of electric air heating components.

Illustration 23. The air drying system of any preceding or subsequent illustration or combination of illustrations, wherein the second conduit is configured to connect an output of the first set of gas air heating components or an output of the first set of electric air heating components to the input of the first end of the Yankee hood.

Illustration 24. The air drying system of any preceding or subsequent illustration or combination of illustrations, further comprising additional conduit within the first air heating system configured to connect the first air circulating fan, the first set of gas air heating components, and the first set of electric air heating components, wherein the additional conduit is configured to allow process air to flow through the electric air heater and the combustion chamber during operation of the first air heating system.

Illustration 25. The air drying system of any preceding or subsequent illustration or combination of illustrations, further comprising: a third conduit configured to receive process air from an output of a second end of a Yankee hood and to provide process air to a second air heating system; a fourth conduit configured to receive process air from the second air heating system and to provide process air to an input of the second end of the Yankee hood; and the second air heating system, comprising: a second air circulating fan; a second set of gas air heating components including a second burner and a second combustion chamber; and a second set of electric air heating components including a second electric air heater, wherein the second air heating system is configurable to operate using only the second set of gas air heating components, only the second set of electric air heating components, or both the second set of gas air heating components and the second set of electric air heating components.

Illustration 26. The air drying system of any preceding or subsequent illustration or combination of illustrations, further comprising a controller, wherein the controller controls the first air heating system and the second air heating system.

Illustration 27. The air drying system of any preceding or subsequent illustration or combination of illustrations, further comprising: first additional conduit within the first air heating system configured to connect the first air circulating fan, the first set of gas air heating components, and the first set of electric air heating components, wherein the first additional conduit is configured to allow process air to flow through the electric air heater and the combustion chamber during operation of the first air heating system; and second additional conduit within the second air heating system configured to connect the second air circulating fan, the second set of gas air heating components, and the second set of electric air heating components, wherein the second additional conduit is configured to allow process air to flow through the second electric air heater and the second combustion chamber during operation of the second air heating system.

Illustration 28. The air drying system of any preceding or subsequent illustration or combination of illustrations, wherein the first end of the Yankee hood is a wet end and the second end of the Yankee hood is a dry end.

Illustration 29. The air drying system of any preceding or subsequent illustration or combination of illustrations, wherein the first set of gas air heating components use natural gas or hydrogen gas.

Illustration 21. An air drying system, comprising: a first conduit configured to receive process air from an output of a first end of a Yankee hood and to provide process air to a first air heating system; a second conduit configured to receive process air from the first air heating system and to provide process air to an input of the first end of the Yankee hood; and the first air heating system, comprising: a first air circulating fan; a first set of gas air heating components including a burner and a combustion chamber; and a first set of electric air heating components including an electric air heater, wherein the first air heating system is external to the Yankee hood and is configurable to operate using only the first set of gas air heating components, only the first set of electric air heating components, or both the first set of gas air heating components and the first set of electric air heating components.

Illustration 22. The air drying system of any preceding or subsequent illustration or combination of illustrations, further comprising a controller, wherein the controller controls the first air heating system so that (i) the burner and the combustion chamber provide the process air from the first air heating system when the first air heating system is configured to operate using only the first set of gas air heating components, (ii) the electric air heater provides the process air from the first air heating system when the first air heating system is configured to operate using only the first set of electric air heating components, or (iii) the burner, the combustion chamber, and the electric air heater provide the process air from the first air heating system when the first air heating system is configured to operate using both the first set of gas air heating components and the first set of electric air heating components.

Illustration 23. The air drying system of any preceding or subsequent illustration or combination of illustrations, wherein the second conduit is configured to connect an output of the first set of gas air heating components or an output of the first set of electric air heating components to the input of the first end of the Yankee hood.

Illustration 24. The air drying system of any preceding or subsequent illustration or combination of illustrations, further comprising additional conduit within the first air heating system configured to connect the first air circulating fan, the first set of gas air heating components, and the first set of electric air heating components, wherein the additional conduit is configured to allow process air to flow through the electric air heater and the combustion chamber during operation of the first air heating system.

Illustration 25. The air drying system of any preceding or subsequent illustration or combination of illustrations, further comprising: a third conduit configured to receive process air from an output of a second end of a Yankee hood and to provide process air to a second air heating system; a fourth conduit configured to receive process air from the second air heating system and to provide process air to an input of the second end of the Yankee hood; and the second air heating system, comprising: a second air circulating fan; a second set of gas air heating components including a second burner and a second combustion chamber; and a second set of electric air heating components including a second electric air heater, wherein the second air heating system is configurable to operate using only the second set of gas air heating components, only the second set of electric air heating components, or both the second set of gas air heating components and the second set of electric air heating components.

Illustration 26. The air drying system of any preceding or subsequent illustration or combination of illustrations, further comprising a controller, wherein the controller controls the first air heating system and the second air heating system.

Illustration 27. The air drying system of any preceding or subsequent illustration or combination of illustrations, further comprising: first additional conduit within the first air heating system configured to connect the first air circulating fan, the first set of gas air heating components, and the first set of electric air heating components, wherein the first additional conduit is configured to allow process air to flow through the electric air heater and the combustion chamber during operation of the first air heating system; and second additional conduit within the second air heating system configured to connect the second air circulating fan, the second set of gas air heating components, and the second set of electric air heating components, wherein the second additional conduit is configured to allow process air to flow through the second electric air heater and the second combustion chamber during operation of the second air heating system.

Illustration 28. The air drying system of any preceding or subsequent illustration or combination of illustrations, wherein the first end of the Yankee hood is a wet end and the second end of the Yankee hood is a dry end.

Illustration 29. The air drying system of any preceding or subsequent illustration or combination of illustrations, wherein the first set of gas air heating components use natural gas or hydrogen gas.

Illustration 30. An air drying system, comprising: a first hybrid gas/electric air heating system connected to a first end of a Yankee hood, wherein the first hybrid gas/electric heating system comprises a first air circulating fan, a first set of gas air heating components, and a first electric air heater, and wherein the first hybrid gas/electric air heating system is external to the Yankee hood and is connected to the first end of the Yankee hood via a first set of conduit; a second hybrid gas/electric air heating system connected to a second end of a Yankee hood, wherein the second hybrid gas/electric heating system comprises a second air circulating fan, a second set of gas air heating components, and a second electric air heater, and wherein the second hybrid gas/electric air heating system is external to the Yankee hood and is connected to the second end of the Yankee hood via a second set of conduit; and a controller, wherein the controller controls the first hybrid gas/electric air heating system and the second hybrid gas/electric air heating system.

Illustration 31. The air drying system of any preceding or subsequent illustration or combination of illustrations, wherein the first set of conduit includes a first conduit connecting the electric heater to the first end of the Yankee hood and a second conduit connecting the first set of gas air heating components to the first end of the Yankee hood.

Illustration 32. The air drying system of any preceding or subsequent illustration or combination of illustrations, further comprising additional conduit to connect the first set of gas air heating components, the electric heater, and the first air circulating fan, wherein the additional conduit is configured to allow process air to flow through the electric air heater and the first set of gas air heating components during operation of the first air heating system.

Illustration 33. The air drying system of any preceding or subsequent illustration or combination of illustrations, wherein the first set of gas air heating components comprises a combustion chamber and a burner, and wherein the controller controls the first hybrid gas/electric air heating system so that (i) the combustion chamber and the burner heat process air when the first hybrid gas/electric air heating system is configured to operate using only the first set of gas air heating components, (ii) the electric air heater heats the process air when the first hybrid gas/electric air heating system is configured to operate using only the first electric air heater, or (iii) the burner, the combustion chamber, and the first electric air heater heat the process air when the first hybrid gas/electric air heating system is configured to operate using both the first set of gas air heating components and the first electric heater.

Illustration 34. The air drying system of any preceding or subsequent illustration or combination of illustrations, wherein the first air circulating fan is located between the first set of gas air heating components and the electric heater.

Illustration 35. The air drying system of any preceding or subsequent illustration or combination of illustrations, wherein the first set of gas air heating components use natural gas or hydrogen gas.

The various implementations illustrated and described are provided merely as examples to illustrate various features of the claims. However, features shown and described with respect to any given implementation are not necessarily limited to the associated implementation and may be used or combined with other implementations that are shown and described. Further, the claims are not intended to be limited by any one example implementation.

The accompanying claims and their equivalents are intended to cover such forms or modifications as would fall within the scope and spirit of the protection. For example, the example apparatuses and systems disclosed herein can be applied to Yankee hoods used in all tissue and/or paper machines where a Yankee cylinder is used to transport wet pulp for hood drying. The examples apply to dryers other than Yankee hoods, including air drying systems in the paper, non-woven, and food processing industries that use heated air flow. The disclosed features allow a flexible configuration of the system to support environmental, fuel cost, and fuel availability concerns. The examples apply to both different types of fuel and different sources of fuel. When there are different sources of fuel, the type of fuel may be the same, but the source of the fuel may differ. When there are different types of fuel, the type of fuel is not limited to the examples discussed above. The air drying components are not limited to the examples shown, but include other components or components with different forms or designs. The features and attributes of the specific example implementations disclosed above may be combined in different ways to form additional implementations, all of which fall within the scope of the present disclosure.

Although the present disclosure provides certain example implementations and applications, other implementations that are apparent to those of ordinary skill in the art, including implementations which do not provide all of the features and advantages set forth herein, are also within the scope of this disclosure. Accordingly, the scope of the present disclosure is intended to be defined only by reference to the appended claims.

1. An air drying system, comprising:
an air return header configured to receive process air from an output of a wet end of a Yankee hood and an output of a dry end of the Yankee hood and to provide process air to a gas air heating system or to an electric air heating system;
an air supply header configured to receive process air from the gas air heating system or the electric air heating system and to supply process air to an input of the wet end of the Yankee hood and an input of the dry end of the Yankee hood;
the gas air heating system, comprising:
a first air circulating fan;
a burner; and
a combustion chamber;
the electric air heating system, comprising:
a second air circulating fan; and
an electric air heater; and
a plurality of dampers, wherein the dampers may be configured to provide process air to the air supply header by only the gas air heating system, only the electric air heating system, or both the gas air heating system and the electric air heating system.

2. The air drying system of claim 1, wherein a first one of the plurality of dampers is located between an output of the electric air heating system and a first input of the air supply header and a second one of the plurality of dampers is located between an output of the gas air heating system and a second input of the air supply header.

3. The air drying system of claim 2, wherein a third one of the plurality of dampers is located between a first output of the air return header and an input of the electric air heating system and a fourth one of the plurality of dampers is located between a second output of the air return header and an input of the gas air heating system.

4. The air drying system of claim 1, wherein the plurality of dampers may be further configured to provide air from the air return header to only the gas air heating system, only the electric air heating system, or both the gas air heating system and the electric air heating system.

5. The air drying system of claim 1, further comprising:
a first conduit connecting the output of the wet end of the Yankee hood to the air return header; and
a second conduit connecting the output of the dry end of the Yankee hood to the air return header,
wherein a diameter of the first conduit is approximately equal to a diameter of the second conduit, and a diameter of the air return header is greater than twice the diameter of the first conduit.

6. The air drying system of claim 1, further comprising:
a third conduit connecting the input of the wet end of the Yankee hood to the air supply header; and
a fourth conduit connecting the input of the dry end of the Yankee hood to the air supply header,
wherein a diameter of the third conduit is approximately equal to a diameter of the fourth conduit, and a diameter of the air supply header is greater than twice the diameter of the third conduit.

7. The air drying system of claim 1, further comprising a controller configured to control operation of the gas air heating system and the electric air heating system, wherein the controller is configured to control a temperature and a volume of air provided by the gas air heating system and a temperature and a volume of air provided by the electric air heating system.

8. The air drying system of claim 7, further comprising a plurality of dampers for controlling process air out of the air return header and process air into the air supply header, wherein the controller is configured to control positions of the dampers.

9. An air drying system, comprising:
an air return header configured to receive process air from an output of a wet end of a Yankee hood and an output of a dry end of the Yankee hood and to provide process air to an air heating system;
an air supply header configured to receive process air from the air heating system and to supply process air to an input of the wet end of the Yankee hood and an input of the dry end of the Yankee hood;
the air heating system, comprising:
an air circulating fan;
gas air heating components including a burner and a combustion chamber; and
electric air heating components including an electric air heater,
wherein the air heating system is configurable to operate using only the gas air heating components, only electric air heating components, or both the gas air heating components and the electric air heating components.

10. The air drying system of claim 9, further comprising a controller, wherein the controller controls the air heating system so that (i) the burner and the combustion chamber provide the process air from the air heating system when the air heating system is configured to operate using only the gas air heating components, (ii) the electric air heater provides the process air from the air heating system when the air heating system is configured to operate using only the electric air heating components, or (iii) the burner, the combustion chamber, and the electric air heater provide the process air from the air heating system when the air heating system is configured to operate using both the gas air heating components and the electric air heating components.

11. The air drying system of claim 9, further comprising:
a first conduit connecting the output of the wet end of the Yankee hood to the air return header; and
a second conduit connecting the output of the dry end of the Yankee hood to the air return header,
wherein a diameter of the first conduit is approximately equal to a diameter of the second conduit, and a diameter of the air return header is greater than twice the diameter of the first conduit.

12. The air drying system of claim 9, further comprising:
a third conduit connecting the input of the wet end of the Yankee hood to the air supply header; and
a fourth conduit connecting the input of the dry end of the Yankee hood to the air supply header,
wherein a diameter of the third conduit is approximately equal to a diameter of the fourth conduit, and a diameter of the air supply header is greater than twice the diameter of the third conduit.

13. The air drying system of claim 9, further comprising:
a fifth conduit connecting the air return header to an input of the air heating system; and
a sixth conduit connecting an output of the air heating system to the air supply header.

14. An air drying system, comprising:
an air return header configured to receive process air from an output of a wet end of a Yankee hood and an output of a dry end of the Yankee hood and to provide process air to a hybrid gas/electric air heating system;
an air supply header configured to receive process air from the hybrid gas/electric air heating system and to supply process air to an input of the wet end of the Yankee hood and an input of the dry end of the Yankee hood;
the hybrid gas/electric air heating system, comprising:
at least one air circulating fan;
gas air heating components, comprising:
a burner; and
a combustion chamber; and
an electric air heating components, comprising:
an electric air heater; and
a controller configured for controlling the hybrid gas/electric air heating system to operate using only the gas air heating components, only the electric air heating components, or both the gas air heating components and the electric air heating components.

15. The air drying system of claim 14, wherein the controller is configured to control a volume of air provided by the at least one air circulating fan, a temperature provided by the gas air heating components, and a temperature provided by the electric air heating components.

16. The air drying system of claim 14, further comprising:
a first conduit connecting the output of the wet end of the Yankee hood to the air return header; and
a second conduit connecting the output of the dry end of the Yankee hood to the air return header,
a third conduit connecting the input of the wet end of the Yankee hood to the air supply header; and
a fourth conduit connecting the input of the dry end of the Yankee hood to the air supply header,
wherein a diameter of the third conduit is approximately equal to a diameter of the fourth conduit, and a diameter of the air supply header is greater than twice the diameter of the third conduit.

17. The air drying system of claim 14, further comprising:
a fifth conduit connecting the air return header to an input of the hybrid gas/electric air heating system; and
a sixth conduit connecting an output of the hybrid gas/electric air heating system to the air supply header.

18. The air drying system of claim 14, further comprising:
a fifth conduit connecting the air return header to a first input of the hybrid gas/electric air heating system associated with the gas air heating components;
a sixth conduit connecting the air return header to second input of the hybrid gas/electric air heating system associated with the electric air heating components;
a seventh conduit connecting a first output of the hybrid gas/electric air heating system associated with the gas air heating components to the air supply header; and.
an eighth conduit connecting a second output of the hybrid gas/electric air heating system associated with the electric air heating components to the air supply header.

19. The air drying system of claim 18, wherein a first air circulating fan of the hybrid gas/electric air heating system is associated with the gas air heating components and a second air circulating fan is associated with the electric air heating components.

20. The air drying system of claim 18, further comprising a plurality of dampers for controlling process air out of the air return header and into the hybrid gas/electric air heating system and process air out of the hybrid gas/electric air heating system into the air supply header, wherein the controller is configured to control positions of the dampers.

21.-35 (canceled).
